(19) United States
(12) Patent Application Publication
(10) Pub. No.: US 2004/0011735 A1
(43) Pub. Date: Jan. 22, 2004

(54) Waste treatment composition and method

(76) Inventor: Melvin Hahn, Okemos, MI (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/399,065

(22) PCT Filed: Oct. 22, 2001
(86) PCT No.: PCT/US01/46693

(51) Int. Cl. C02F 5/02

(52) U.S. Cl. 210/610; 252/175

(57) ABSTRACT

A composition and method for treatment of waste water having beneficial bacteria added thereto, which bacteria are used to break down and consume plant biological materials are disclosed where the composition comprises at least one of the following: urea ammonium nitrate, ammonium polyphosphate, and urea liquor.

### BACKGROUND OF THE INVENTION

The use of bacteria in waste treatment is well known in the art. Effluent from organic material often cannot be pumped into streams because the levels of pollutants such as organic waste (for example, sugar and carbohydrates) are too high. The level of these and other pollutants in water is measured as “biological oxygen demand” or BOD. The BOD is the amount of biological activity required to break down pollutants present in the effluent.

The pollution potential which results from a very high biological oxygen demand (BOD) is generated wherever there is an excess of carbohydrates, sugars or organic materials. Various industries, such as pulp and paper mills, municipal treatment plants, lagoon systems, biodigesters, and chemical companies produce such effluent with high BOD. In addition, high BOD is generated from food processing plants (i.e., beets, cotton and the like), hog farms and chicken farms. For example, if the effluent from a paper or pulp plant were released into a stream or lake, the bacteria present in the stream or lake would begin to breakdown and consume the sugars in the effluent. In doing so, the bacteria would also consume much of the oxygen in the stream or lake, thus robbing the oxygen needed for aquatic plant and animal life. Often, fish kills and down stream pollution result.

In the pulp and paper industry, water is used to wash or clean the raw wood pulp of sugars and carbohydrates, which are naturally, present in the raw material wood. This “wash water” results in effluent from the process, which contains high amounts of sugars and carbohydrates. To lower the BOD, the water must first be cleaned by removing or lowering the level of sugars and carbohydrates present. This is accomplished by treating the effluent in a waste water treatment plant or pond. The resulting treated water may then be released into open streams and lakes.

In the paper and pulp industry, the treatment process often involves a series of holding ponds connected to a water treatment plant. Additional bacteria are added to the holding pond water to speed the consumption and breakdown of the sugars in the effluent. It is known in the art that the performance of the treatment system and the bacteria therein is significantly enhanced by adding proper amounts of nitrogen (N) and phosphorous (P) to the water in the holding ponds. This creates an environment where the bacteria enjoy a more properly balanced source of nutrient. The bacteria are in turn stimulated to grow and reproduce more rapidly resulting in higher -consumption of the undesirable sugars and carbohydrates.

The prior art solutions to these problems have normally used anhydrous ammonia and phosphoric acid for the sources of nitrogen and phosphorous, respectively. Inclusion of the anhydrous ammonia and phosphoric acid into the waste water is typically accomplished by separately pumping a desired amount of each of the chemicals into the settling ponds where the bacteria are present. A major drawback to these solutions is that each chemical must be typically stored and handled separately, thus requiring separate storage tanks, pumping and handling systems.

While the prior art process is and has been used for years, still other problems arise with the use of anhydrous ammonia and phosphoric acid, particularly in today's environmentally conscious world. Both anhydrous ammonia and phosphoric acid are classified and labeled as hazardous. Each requires special storage vessels and handling precautions. Ammonia is a caustic and toxic gas and can be very dangerous if a leak occurs. Further, ammonia is classified as an inhalation hazard. U.S. EPA considers anhydrous ammonia an “extremely hazardous substance” and tracks its use closely. Anhydrous ammonia is therefore very hazardous. As the raw ammonia gas is pumped into a treatment pond, it is not unusual to have gas released into the air. This, of course, creates problems with respect to complaints from surrounding areas and neighbors. Also, anhydrous ammonia must be stored under pressure in special anhydrous ammonia storage tanks. This use of anhydrous ammonia requires extra personnel to handle the separate storage and delivery system together with special training of personnel.

Phosphoric acid, while comparatively safer than ammonia gas (a caustic base), is a caustic acid and is also classified as a hazardous material. Phosphoric acid also requires its own separate storage and handling system, including special training of personnel; special handling procedures, special plumbing, and special storage tanks with proper secondary containment. The phosphoric acid is typically pumped directly into the settling ponds and can also be an environmental problem if spilled.

While the above process of combining anhydrous ammonia and phosphoric acid does ultimately work to decrease the organic pollutants and improve the BOD levels, there are other problems with this prior art process. The use of the phosphoric acid and the anhydrous ammonia provides a caustic combination of acid and base that tends to kill a proportion of the bacteria. The bacteria population must then replenish itself which takes time and energy. Therefore, there is a need for a composition, which is more efficient and less, detrimental to the beneficial bacteria being used to treat the waste.

A need also exists for a treatment system that addresses all the environmental concerns presented by biological waste, while at the same time not involving high capital costs.

A need exists for a product which presents less risks to handlers and which is environmentally friendly and employee safe. It would be of great environmental benefit to have an inexpensive and safe composition and method for reducing biological oxygen demand (BOD) in waste.

There is a further need to provide a product that can be delivered in a convenient and safe manner to the end user.

There is a further need to provide a waste treatment, composition and method, which are less caustic in nature to the waste material being treated.

### SUMMARY OF THE INVENTION

The present invention is directed to a composition and a method of treating waste which reduces many of the problems of the prior art, particularly the environmental problems. The composition and method of treating waste according to the present invention are classified as neither toxic nor hazardous. The composition and method may be used in all types of waste treatment systems where it is desired to add nitrogen (N) and/or phosphorous (P) to stimulate proper bacteria growth.

The composition and method supplies both the required nitrogen and phosphorous to waste treatment ponds or treatment plants. The composition is supplied to the ponds as a single product and only requires a singl , simple storage and handling system. The composition is a clear liquid, which has no odor and has a desired relatively neutral pH in the range of about 5.6 to about 6.8. The composition comprises, in combination, preferred amounts of urea ammonium nitrate, ammonium phosphate, water and free urea (urea liquor).

The present invention comprises a composition and a method, which is especially useful in the treatment of waste water having beneficial bacteria added thereto. In such treatments of waste water, the bacteria have been added to the waste water to break down and consume the plant or organic biological material, thereby reducing the BOD. The composition and method, while useful in stimulating bacteria for use in the organic waste treatment systems, can also be used effectively for any waste water treatment system where sugars, carbohydrates, proteins or other undesirable factions are to be consumed, reduced, or removed by the appropriate bacteria.

The composition of the present invention has a combination of nitrogen and phosphorous which provides a pH balanced composition which is more palatable to the beneficial bacteria. The composition of the present invention is not caustic and does not kill bacteria and, therefore works more efficiently. In various test examples it has been shown that use of the composition of the present invention uses up to 85% less material than prior art products. Since less of the composition of the present invention is necessary to produce favorable results, the cost of using the composition is less than currently available methods of treating waste.

One major advantage of the present invention is that the composition of the present invention can be mixed together by a producer and sent to the end user in a single tank. There is no need to keep separate the ingredients such as in the prior art wherein anhydrous ammonia and phosphoric acid had to be separately delivered to the end user and stored in separate areas until use.

Further, the present invention allows the end user to have delivered a product which is ready to use and can be readily modified according to the needs of the waste being treated. For example, when the temperature, rainfall, or amount of waste product being, produced changes or where different trees or pulp that have different amounts of carbohydrates and sugar are part of the waste, the end user must vary the amounts of nitrogen and phosphorous being delivered. According to the present invention, the composition can be readily changed to meet the needs of the end user.

Another advantage of the present invention is that a portion of the nitrogen present in the composition is in the form of nitrate nitrogen. This is a significant and key difference in the formulation of the present invention over prior art formulations. The amount of nitrate nitrogen in the composition of the present invention has the following advantages. There are at least two important forms of nitrogen molecules: ammonium (NH₄) and nitrate (NO₃) molecules. Bacteria prefer to consume both nitrate and ammonium nitrogen and the bacteria perform better when the bacteria have access to both forms of nitrogen.

Since the bacteria live in an aerobic environment and require oxygen to survive, much of the oxygen comes from the free oxygen in the water. Bacteria may also get some of the required oxygen while consuming the nitrate form of nitrogen because the nitrate molecules NO₃ contain three units of oxygen along with the nitrogen. The absence of nitrate nitrogen in the water requires bacteria to live solely on ammonium nitrogen, which prevents optimum efficiency in the consumption sugars and carbohydrates.

In order to have the most efficient reduction in BOD, there must be a proper balance of NH₄, NO₃ and O₂ present in the waste water. When oxygen in the water is low or in short supply, the bacteria begin to seek out other sources of oxygen in the water. Normally the bacteria seek nitrate (NO₃) molecules since they are a source of both oxygen and nitrogen. If both oxygen and NO₃ molecules are low or in short supply, bacteria seek out oxygen from sources such as sulfate (SO₄) molecules, which are often naturally present in most waste water. In this case, the bacteria will remove the oxygen from the SO₄ molecule. Removal of the oxygen from the sulfate molecules eventually results in the formation of hydrogen sulfide gas. This gas results in undesirable odors since hydrogen sulfide gas has a smell of rotten eggs. Thus, the absence of sufficient oxygen along with low or no nitrates in the water can result in increase in undesirable odors from the treatment system.

If there is no or insufficient nitrate nitrogen in the water, the bacteria can convert the urea nitrogen into the nitrate form in order to, have nitrates available for consumption. However, this conversion of urea nitrogen to the nitrate form by the bacteria requires time and energy which makes the conversion process a less efficient method.

The formulation of the present invention may include a preferred amount of nitrogen already in the nitrate form. The presence of the nitrogen in a nitrate form improves the efficiency of the bacterial conversion of sugars and carbohydrates in the waste water. In preferred embodiments, the nitrates in the composition are present at about 10 to about 25% of all nitrogen in the composition.

Another advantage of the present invention is that desired ratios of nitrogen to phosphorous present in the composition are optimized. It is to be understood that the ratio of nitrogen to phosphorous in the composition of the present invention can range from about 10 to 35 nitrogen to about 10 to 0 phosphorous, depending on the desired use of the composition. Certain preferred embodiments have the following ranges of nitrogen to phosphorous ratios: about 7-8 nitrogen to 1 phosphorous; 7 nitrogen to 3 phosphorous; 8 nitrogen to 3 phosphorous, 10 nitrogen to 0 phosphorous; 14 nitrogen to 1 phosphorous, 9-10 nitrogen to 1 phosphorous; and 17-18 nitrogen to 1 phosphorous.

In certain embodiments, a preferred maximum percent of nitrogen to phosphorous in the ingredients of the composition is shown in the Table I below.

TABLE I

| | N | P |
|---|---|---|
| Urea Ammonium Nitrate (UAN) | 32% | 0 |
| Ammonium Polyphosphate (APP) | 11% | 37% |
| Water and free urea (Urea Liquor-UL) | 25% | 0% |

Table II shows the results of use of the waste water treatment composition of the present invention in treating pulp and paper mill effluent throughout a one-year period of time as compared to a previous year. The percent reduction in nutrients steadily increased throughout the year.

TABLE II
PLANT DATA FROM PULP & PAPER MILL

| | | | | | | 2000 | 1999 | 1999 to 2000 |
|---|---|---|---|---|---|---|---|---|
| | | | | | | Total Lbs | Total Lbs | Reduction |
| | | Influent | Gross | Effluent | | Nutrients | Nutrients | % Reduction |
| | Flow | BOD | Influent | BOD | Composition | From | From | With |
| Month | GPM | (mg/L) | Flow | (mg/L) | Flow GPD | Composition | NH3 + Phos | Composition |
| Jan-00 | 987 | 4762 | 4698184 | 329 | 1040 | 2497 | 2572 | 3% |
| Feb-00 | 943 | 5232 | 4934498 | 518 | 976 | 2342 | 2771 | 15% |
| Mar-00 | 917 | 3894 | 3570872 | 387 | 767 | 1841 | 2684 | 31% |
| Apr-00 | 1048 | 5027 | 5267608 | 458 | 506 | 1213 | 3181 | 62% |
| May-00 | 1014 | 4499 | 4560245 | 429 | 537 | 1290 | 3133 | 59% |
| Jun-00 | 1063 | 3807 | 4046614 | 322 | 406 | 975 | 2880 | 66% |
| Jul-00 | 1045 | 3380 | 3532536 | 283 | 227 | 545 | 3067 | 82% |
| Aug-00 | 894 | 3774 | 3375598 | 332 | 223 | 536 | 3029 | 82% |
| Sep-00 | 1025 | 3764 | 3858401 | 168 | 184 | 442 | 3047 | 85% |
| Oct-00 | 924 | 3821 | 3530833 | 194 | 148 | 356 | 2996 | 88% |
| Nov-00 | 975 | 3983 | 3881602 | 313 | 150 | 359 | 2479 | 86% |
| Dec-00 | 1139 | 5104 | 5815211 | 595 | 119 | 286 | 2720 | 89% |
| Average/Total | 955 | 3836 | 4256017 | | 176 | 423 | 2888 | 85% |
| Aug. thru Nov. | | | | | | | | |

Note:
1999 Nutrients derived from Anhydrous Ammonia and Ammonium Polyphosphate
2000 Nutrients derived from Composition

The present invention also provides an improved method for treatment of waste water by combining the ingredients of the composition together into a single product, which can then be stored in a single tank. The composition is added to a waste treatment tank or pond where the desired bacteria are present. As shown in Table II, the composition and method of the present invention provides a non-toxic, neutral pH composition, which is non-hazardous and non-corrosive. Use of the composition is employee friendly, bacteria friendly and environmentally friendly. There are no special handling needs and the material is useable without needing to be transported or stored under pressure. The composition requires no mixing by the end user prior to being added into the waste water. Further, no special equipment is required in order to receive, store, handle or deliver the composition into the waste water system.

The ingredients in the composition, according to the invention, can be present in different amounts, depending on the need to stimulate bacteria growth and/or the waste being treated. Table III below shows various ranges in parts by weight, of the ingredients, which are useful.

TABLE III

| | Broad | Intermediate | Narrow |
|---|---|---|---|
| Urea Ammonium Nitrate (UAN) | 0-100% | 40-55% | 44-50% |
| Ammonium Polyphosphate (APP) | 0-25% | 3-15% | 4-8% |
| Water and Free Urea (urea liquor-UL) | 0-100% | 30-57% | 46-52% |

Table IV shows one preferred embodiment of the composition designed specifically for the paper and pulp industry.

TABLE IV
Parts By Weight

| | |
|---|---|
| Urea Ammonium Nitrate (UAN) | 46% |
| Ammonium Polyphosphate (APP) | 8% |
| Water and Free Urea (urea liquor-UL) | Balance |

The composition in Table IV has a specific gravity of 1.20 and a pH of 6.00-6.25. The nitrogen to phosphorous ratio is 8:1. It should be understood, however, in treating different types of wastes, different ratios of nitrogen and phosphorous may be present in the composition product. Tables V and VI show further compositions, in parts by weight, of ingredients that are also useful.

TABLE V

| | |
|---|---|
| UAN | 45.3% |
| APP | 7.7% |
| Urea Liquor | 47% |

TABLE VI

| | |
|---|---|
| UAN | 50.0% |
| APP | 4.5% |
| Urea Liquor | 45.2% |

It is to be understood that the composition of the present invention and its use is compatible with growth enhancers and biostimulants, which are used to aid in the growth of the b neficial bacteria. The growth enhancers have optimum amounts of essential nutrients. The choice and amount of biostimulant varies as a function of various factors including type of bacteria present, the composition's ingredients, the composition of the waste water being treated, and climatic and environmental conditions. In certain embodiments it is useful to include certain biostimulants such as organic acids and/or auximones, including humic and fluvic acids which improve palatability and digestion of waste material, as well as amino acids, amino purines, butyric acid, gibberellic acid and folic acids for additional carbon and energy sources. Additionally, certain embodiments may also include other biostimulants such as enzymes, cytokinins, glycine betaine, and methyl glucoside for increased metabolism, and iron and other trace elements for proper energy conversion and bacterial community health.

Many revisions may be made to the ranges in the composition, as indicated in the Examples above without departing from the scope of the present invention.

I claim:

1. (Amended) A composition for use in treatment of waste water having beneficial bacteria added thereto, which bacteria are used to break down and consume plant biological materials, the composition comprising, in parts by weight, about:
40-55% urea ammonium nitrate;
3-15% ammionium polyphosphate; and
30-57% urea liquor.

2. CANCELLED.

3. CANCELLED.

4. CANCELLED.

5. CANCELLED.

6. CANCELLED.

7. CANCELLED.

8. CANCELLED.

9. The composition of claim 1, wherein the combination of nitrogen and phosphorous in the composition provides a composition having a pH in the range of about 5.6 to 6.8.

10. The composition of claim 1, wherein the composition further includes at least one biostimulant.

11. CANCELLED.

12. CANCELLED.

13. (Amended) The composition of claim 1, comprising about, in parts by weight:
44-50% urea ammonium nitrate;
4-8% ammonium polyphosphate; and
44-52% urea liquor.

14. The composition of calim 10, wherein tiie biostimulant comprises at least one of: organic acids and/or auximones, including humic and fluvic acids, amino purines, butyric acid, gibberellic acid and folic acids; enzymes, cytokinins, glycine betaine, and methyl glucoside, iron and other trace elements.

15. (Amended) A method treatment of waste water having beneficial bacteria added thereto, which bacteria are used to break down and consume biological materials, the method comprising combining: urea ammonium nitrate, ammonium polyphosphate, and urea liquor together to form a mixed composition, wherein the composition comprises, in parts by weight, about: 40-55% urea ammonium nitrate; 3-15% ammonium polyphosphate; and 30-57% urea liquor; and, delivering the mixed composition to the waste water.

16. CANCELLED.

17. CANCELLED.

18. CANCELLED.

19. CANCELLED.

20. CANCELLED.

21. CANCELLED.

22. CANCELLED.

23. The method of claim 15, wherein the combination of nitrogen and phosphorous in the composition provides a composition having a pH in the range of about 5.6 to about 6.8.

24. (Amended) The method of claim 15, wherein the composition further includes at least one biostimulant.

25. CANCELLED.

26. CANCELLED.

27. The method of claim 15, comprising about, in parts by weight:
44-48% urea ammonium nitrate;
4-8% ammonium polyphosphate; and
44-52% urea liquor.

28. (Amended) The method of claim 24, wherein the biostimulant comprises at least one of: organic acids and/or auximones, including humic and fluvic acids, amino purines, butyric acid, gibberellic acid and folic acids; enzymes, cytokinins, glycine betaine, and methyl glucoside, iron and other trace elements.
